(19) United States
(12) Patent Application Publication
(10) Pub. No.: US 2014/0321643 A1
(43) Pub. Date: Oct. 30, 2014

(54) METHOD OF GENERATING MULTI-DIMENSIONAL KEY

(71) Applicants: Li LIU, San Francisco, CA (US); Steve Yi long CHAO, San Francisco, CA (US); Chenggong YANG, San Francisco, CA (US)

(72) Inventors: Li LIU, San Francisco, CA (US); Steve Yi long CHAO, San Francisco, CA (US); Chenggong YANG, San Francisco, CA (US)

(21) Appl. No.: 13/872,106

(22) Filed: Apr. 27, 2013

(51) Int. Cl. H04L 9/08; H04L 9/32

(52) U.S. Cl. CPC H04L 9/0861; H04L 9/3242
USPC 380/45

(57) ABSTRACT

A method of generating multi-dimensional key comprises both generating three-dimensional coordinate sequences and generating public key and private key, wherein generating three-dimensional coordinate sequences is: setting the base of three-dimensional key as M comprising of m×l×h key elements, each layer in a three-dimensional matrix being a two dimension matrix sized m×l along Z axis, wherein, m is the number of rows in each layer of Mₖ, l is the number of columns in each layer of Mₖ, k=1, . . . , h; the public key and private key are generated in a manner consistent with the generation of the three-dimensional coordinate sequences. In the present invention, the coordinates of a matrix are picked up by ID-coordinates transformation under the condition of a multi-dimensional matrix, which employs the method of hierarchical processing. The number of key combinations of multi-dimensional matrix is far higher than that of the two-dimensional matrix with the guarantee of not changing data size, thereby increasing the capacity of the key database, and enhancing the availability of the key data package.

### TECHNICAL FIELD

The present invention relates to a method of generating key, and particularly a method of generating multi-dimensional key for self-authenticated cryptography.

### BACKGROUND OF THE INVENTION

With the rapid development of Internet, people are more concerned about how to obtain resources and data safely and efficiently. Meanwhile, data safety and encryption and decryption technology emerge at the right time. There are two common encryption algorithms: Symmetric Cryptography Algorithm and Asymmetric Cryptographic Algorithm. In the former, same passwords are used in the encryption and decryption process; while in the latter, different keys are used in the encryption and decryption process.

In the network environment, asymmetric cryptographic way has been proven an effective information protection mean. In the system of asymmetric cryptographic key, users employ the form of public and private key pair to authenticate and encrypt data. At present, mainstream asymmetric cryptographic key applications are based on PKI system, however, obtaining and authenticating the public key of the PKI system are conducted by the third party certificate authority and online database, and the transmission of public key also occupies a lot of network resources. Therefore, a self-authenticated key system, as a typical of asymmetrical cryptographic key, can work independent of the third party by the separation of authentication and encryption.

FIG. 1 shows the structure of self-authenticated key system. The entity sends its unique identity of ID to Key Generation Center (KGC), KGC carries on a certain conversion to the ID, namely the private key matrix as shown in FIG. 1 can generate the private key for users. KGC also sends the public key matrix to the entity while sending the private key. In doing so, in the cases where a user knows the unique identity of other users, the public key thereof can be generated through the public key matrix. That is to say, the acquiring of public key is independent of the third party, achieving a self-authenticated process.

FIGS. 2 and 3 respectively show the flows of data authentication and encryption in a self-authenticated key system. In the process of data authentication and encryption, the exchange of key is not conducted through the third party, similar to such organs as Certificate Authority (CA), but is conducted in both parties in communication. Namely, the sender and the receiver can both self-determine respective public keys based on the identities provided by the other, and authenticate the private key signature of the other part. In addition, a user can determine the public key thereof based on the public identity of any other users, and data is encrypted and transmitted by using the public key of this user, thereby achieving data exchange and sharing with a specific user. In these processes, the obtaining of public key is conducted without the help of the third party, thereby reducing wastes of network resources, and increasing the safety of data encryption and authentication.

It can be seen that the core of the self-authenticated key system is that users locally obtain the public key of any unit within the system on real time. A public key scheme, as described in a key management and authentication model for AD Hoc network, (by Jianwei Liu, Chun Liu, Keqiang Guo, the 18th Annual IEEE International Symposium on Personal, Indoor and Mobile Radio Communications, Athens, Greece, 2007.), was proposed which can obtain the public key locally. This solution is based on combination public key theorem of Elliptic Curve Cryptography (ECC), in which, key pairs of the user is formed by combining some elements in the public key base and private key base. The public key base and private key base elements are stored as two-dimensional matrices, and the public key are generated by the operation on rows and columns of the matrix. For the matrix of m×h, the amount of public keys can be m^{h}.

### SUMMARY OF THE INVENTION

The technical problem that the invention aims to solve is to provide a method of generating multi-dimensional key in a way that the key base is organized by using a high-dimensional matrix based on public key combination theorem.

The technical solution employed by the invention is as follows: a method of generating multi-dimensional key comprises both generating three-dimensional coordinate sequences and generating public key and private key, wherein the step of generating three-dimensional coordinate sequences is: setting a three-dimensional key base matrix as M, comprising of m×l×h key elements, each layer in a three-dimensional matrix being a two-dimensional matrix Mₖ sized m×l along Z axis, wherein, m is the number of rows in each layer of Mₖ, l is the number of columns in each layer of Mₖ, k=1, . . . , h; the public key base and private key base matrices are generated in a manner consistent with the generation of the three-dimensional coordinate sequences.

Generating three-dimensional coordinate sequences particularly includes following steps:

1) setting a three-dimensional matrix to include h two-dimensional matrices Mₖ having m rows and l columns along Z axis, wherein, k=1, . . . , h;

2) firstly, conducting Hash transformation (or any appropriate mapping) to ID to generate high-dimensional coordinate sequence P for element selection from the key matrix,

P=Hash(ID)=[Pₗ . . . Pₖ . . . Pₕ]

wherein, Pₖ corresponds to the two-dimensional coordinate pickup sequence of two-dimensional matrix of Mₖ of the k^{th} layer, including l units, which corresponds to the number of columns of Mₖ;

Pₖ=[pₖ₁pₖ₂ . . . pₖₗ]

wherein, pₖⱼ, j=1, 2, . . . , l, which is the row coordinate of the elements to be picked up from the j^{th} column of the two-dimensional matrix Mₖ extending in x and y axis direction, the value ranges from 1 to m;

3) P can be expressed in a two-dimensional form. It contains h 1×l vectors Pₖ,

$$\begin{matrix}P = [ \begin{matrix}{P}_{1} \\ {P}_{2} \\ ⋮ \\ {P}_{h}\end{matrix} ] \\ = [ \begin{matrix}{p}_{11} & {p}_{12} & … & {p}_{1 l} \\ {p}_{21} & {p}_{22} & … & {p}_{2 l} \\ ⋮ & ⋮ & ⋱ & ⋮ \\ {p}_{h 1} & {p}_{h 2} & … & {p}_{hl}\end{matrix} ]\end{matrix}$$

wherein, pₖⱼ, p, k=1, 2, . . . , h; j=1, 2, . . . , l, which indicates the row ordinates of the elements picked up from the j^{th} column in the two-dimensional matrix Mₖ, k=1, 2, . . . , h of k^{th} layer, and pₖⱼ being 0≦pₖⱼ≦m, k=1, 2, . . . , h; j=1, 2, . . . , l.

For even higher dimensional key base matrices, the coordinate sequences of the elements to be picked up from the base matrix are determined using the method of generating three-dimensional coordinate sequences.

Generating the public key and private key includes following steps:

1) for high-dimensional matrices of public key and private key, taking a three-dimensional matrix for example, the elements to be picked up are obtained by the method of generating three-dimensional coordinate sequences, the public key matrix and private key matrix are R_{m×l×h} and r_{m×l×h}, respectively;

the elements which public key matrix corresponds to

R̅=[Rₚ_{₁₁} . . . Rₚ_{₁ₗ}Rₚ_{₂₁} . . . R_{₂ₗ} . . . Rₚ_{ₕₗ}]

the elements which private key matrix corresponds to

r̅=[rₚ_{₁₁} . . . rₚ_{₁ₗ}rₚ_{₂₁} . . . rₚ_{₂ₗ} . . . rₚ_{ₗₕ}];

the lower index pᵢⱼ, i=1, 2, . . . h, j=1, 2, . . . , l of corresponding elements of above public key matrix and private key matrix correspond to the elements in the three-dimensional coordinate sequence, i indicates that the public key element and private key element Rₚ_{ᵢⱼ}, rₚ_{ᵢⱼ} are in the i^{th} layer of the public key matrix and private key matrix R_{m×l×h} and r_{m×l×h}, j indicates that the public key element and private key element Rₚ_{ᵢⱼ}, rₚ_{ᵢⱼ} are in the pᵢⱼ^{th} row of the j^{th} column in the i^{th} layer pubic key matrix and private key matrix R_{m×l×h} and r_{m×l×h}, pᵢⱼ indicates that the public key element and private key element Rₚ_{ᵢⱼ}, rₚ_{ᵢⱼ} are in the pᵢⱼ^{th} row of the j^{th} column in the i^{th} layer matrix of the public key matrix and private key matrix R_{m×l×h} and r_{m×l×h};

2) the identity private key as

$$SK ( ID ) = {\sum }_{i}^{ } {r}_{i} mod n$$

which a user corresponds to is obtained by a key generation center based on picking up method of matrix elements in above step 1), wherein, n is the order of additive group of an elliptic curve; the user fetches a certain identity public key of the identifier user as

$$PK ( ID ) = {\sum }_{i} {R}_{i}$$

using an open public key matrix;

3) there are m^{l} combination ways in each layer of the three-dimensional matrix, therefore, there are (m^{l})^{h} combination ways in the three-dimensional combination matrix, m, l, h respectively indicate the row number, the column number and the layer number of the three-dimensional public key matrix and private key matrix.

The method of generating multi-dimensional key of the present invention replaces traditional two-dimensional combination matrix with multi-dimensional matrix. Under the condition of a multi-dimensional matrix, the coordinates of a matrix are picked up by Hash transformation (not limited to Hash, can be any ID to coordinates transformation), which employs the method of hierarchical processing. In this invention, a three-dimensional matrix is taken as an example to describe, dividing the three-dimensional matrix into various layers according to the vertical coordinate, and then picking up the corresponding elements in each layer of two-dimensional matrix as combination elements of public key matrix and private key matrix by ID to coordinates transformation of the identity After above improvements on the combination matrix, the number of key combination of the multi-dimensional matrix is far higher than that of the two dimension matrix with the guarantee of not changing data size, thereby increasing the capacity of the key database, and enhancing the availability of the key data package.

### BRIEF DESCRIPTION OF THE DRAWINGS

FIG. 1 is the diagram of self-authenticated key structure in the prior art;

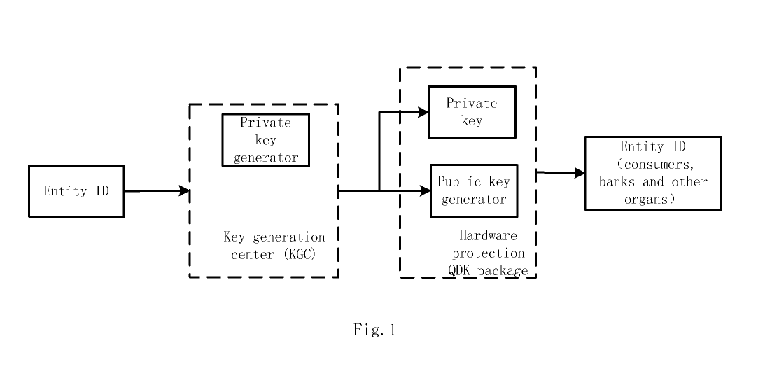

FIG. 2 is the flowchart of data authentication in the prior art;

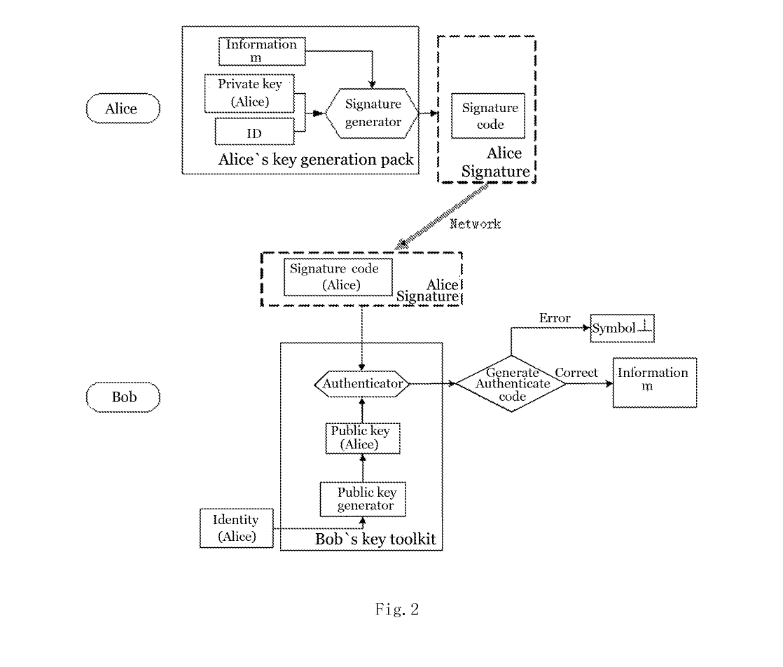

FIG. 3 is the transmission flowchart of data encryption in the prior art;

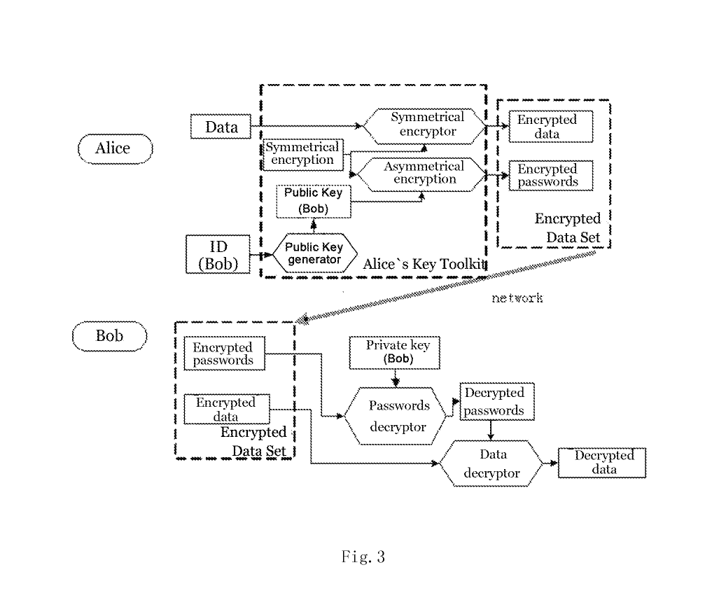

FIG. 4 is the schematic diagram of a key matrix of the present inventive;

FIG. 5 is the schematic diagram of a ID-coordinates transformation of the present inventive.

### DETAILED DESCRIPTION OF THE PREFERRED EMBODIMENT

The method of generating multi-dimensional key of this invention is described in detail hereinafter with reference to the drawings in combination with embodiments.

The implementation of the above-mentioned method of the present invention is described by a three-dimensional matrix as an example. However, the present invention also covers key management means of any-dimensional key matrix. The following description does not distinguish between public key and private key base matrices in the description, and both expressions and processing ways are consistent.

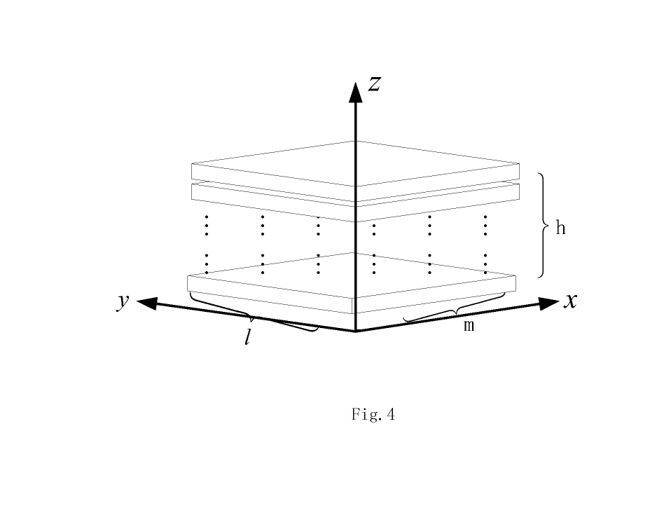

The method of generating multi-dimensional key of this invention includes both generating three-dimensional coordinate sequence and generating public key and private key. Generating three-dimensional coordinate sequence is particularly as follows: as shown in FIG. 4, setting three-dimensional key base matrix as M, comprising of m×l×h key elements (public key or private key). Each layer in the three-dimensional matrix is a two-dimensional matrix Mₖ sized m×l along Z axis, wherein, m is the number of rows in each layer of Mₖ, l is the number of columns in each layer of Mₖ, k=1, . . . , h. The public key and private key base matrices are generated in a manner consistent with the generation of three-dimensional coordinate sequence.

Generating three-dimensional coordinate sequences particularly includes following steps:

1) As shown in FIG. 4, the three-dimensional matrix is set to include h two-dimensional matrices Mₖ having m rows and l columns along Z axis of the matrix, wherein, l=1, . . . , h;

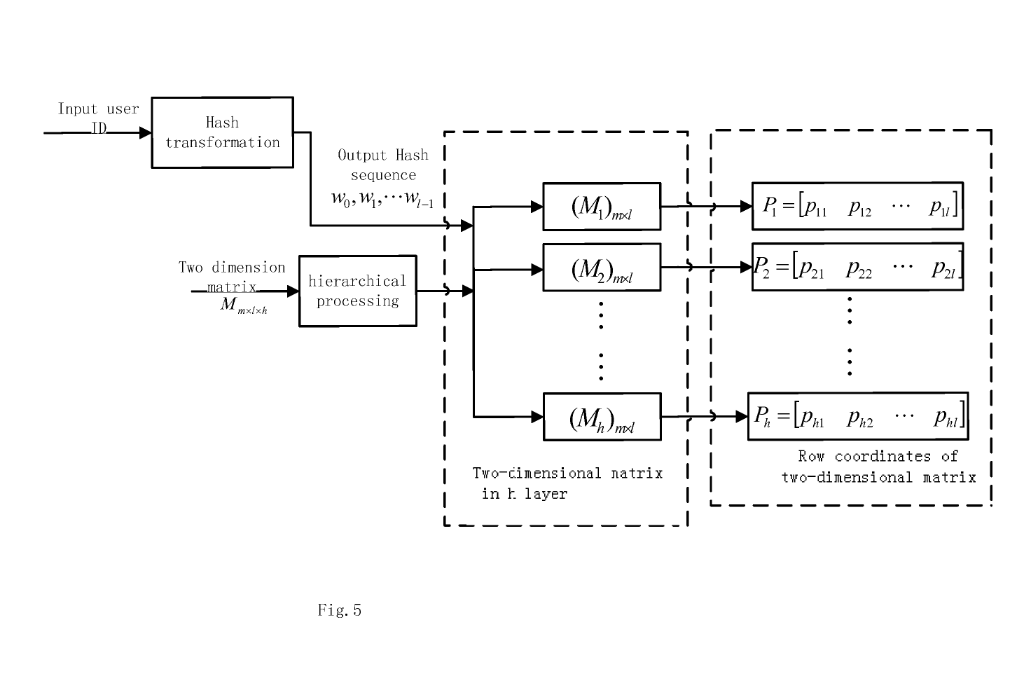

2) when generating coordinate sequence, firstly, conducting ID-sequence transformation to the identity of ID to generate high-dimensional coordinate pickup sequence P, wherein, the flowchart of such transformation using Hash function is shown in FIG. 5.

P=Hash(ID)=[P₁ . . . Pₖ . . . Pₕ]

wherein, Pₖ corresponds to the two-dimensional coordinate pickup sequence of two-dimensional matrix of Mₖ of the k^{th} layer, a total of l units, which corresponds to the number of columns of Mₖ;

Pₖ=[pₖ₁pₖ₂ . . . pₖₗ]

where, pₖⱼ, j=1, 2, . . . , l, which is the row coordinate of the elements to be picked up from the j^{th} column of the two-dimensional matrix Mₖ extending in xy direction as shown in FIG. 4, the value ranges from 1 to m;

3) A high-dimensional sequence P containing the sequence picked up from the coordinates of element having h l-units is generated from the input identity ID by ID-coordinate transformation. P is expressed as a two-dimensional form:

$$\begin{matrix}P = [ \begin{matrix}{P}_{1} \\ {P}_{2} \\ ⋮ \\ {P}_{h}\end{matrix} ] \\ = [ \begin{matrix}{p}_{11} & {p}_{12} & … & {p}_{1 l} \\ {p}_{21} & {p}_{22} & … & {p}_{2 l} \\ ⋮ & ⋮ & ⋱ & ⋮ \\ {p}_{h 1} & {p}_{h 2} & … & {p}_{hl}\end{matrix} ]\end{matrix}$$

where, pₖⱼ, k=1, 2, . . . , h; j=1, 2, . . . , l, which indicates the row ordinates of the elements picked up from the j^{th} column in the two-dimensional matrix Mₖ, k=1, 2, . . . , h of the k^{th} layer, and pₖⱼ being 0≦pₖⱼ≦m, k=1, 2, . . . , h; j=1, 2, . . . , l.

For even higher dimensional key base matrices, the coordinate sequences of the elements to be picked up from the base matrix are determined using the method of generating three-dimensional coordinate sequences.

The generating public key and private key includes following steps:

1) The classic algorithm of ECC is taken as an example to state the generation of public key and private key. For high-dimensional public key matrix and private key matrix R_{m×l×h} and r_{m×l×h}, the elements to be picked up are obtained by the method of generating three-dimensional coordinate sequences:

the elements which public key matrix corresponds to

R̅=[Rₚ_{₁₁} . . . Rₚ_{₁ₗ}Rₚ_{₂₁} . . . Rₚ_{₂ₗ} . . . Rₚ_{ₕₗ}],

the elements which private key matrix corresponds to

r̅=[rₚ_{₁₁} . . . rₚ_{₁ₗ}rₚ_{₂₁} . . . rₚ_{₂ₗ} . . . rₚ_{ₕₗ}];

the subscript pᵢⱼ, i=1, 2, . . . h, j=1, 2, . . . l of corresponding elements in above public key matrix and private key matrix corresponds to the element in the three-dimensional coordinate sequence, i indicates that the public key element and private key element Rₚ_{ᵢⱼ}, rₚ_{ᵢⱼ} is in the i^{th} layer of the public key matrix and private key matrix R_{m×l×h} and r_{m×l×h}, j indicates that the public key element and private key element Rₚ_{ᵢⱼ}, rₚ_{ᵢⱼ} are in the j^{th} column of the i^{th} layer of the pubic key matrix and private key matrix R_{m×l×h} and r_{m×l×h}, pᵢⱼ indicates that the public key element and private key element Rₚ_{ᵢⱼ}, rₚ_{ᵢⱼ} is in the pᵢⱼ^{th} row of the j^{th} column in the i^{th} layer matrix of the public key matrix and private key matrix R_{m×l×h} and r_{m×l×h}.

2) The identity private key as

$$SK ( ID ) = {\sum }_{i}^{ } {r}_{i} mod n$$

which a user corresponds to is obtained by a key generation center (KGC) based on picking up method of matrix elements in above step 1), wherein, n is the order of additive group of an elliptic curve; the user can fetch a certain identity public key of the identified user as

$$PK ( ID ) = {\sum }_{i} {R}_{i}$$

using an open public key matrix.

3) There are m^{l} combination ways in each layer of the three-dimensional matrix, therefore, there are (m^{l})^{h} combination ways in the three-dimensional combination matrix, m, l, h respectively indicate the row number, the column number and the layer number of the three-dimensional public key matrix and private key matrix.

Take a two-dimensional matrix of 32×32 and a three-dimensional matrix of 16×16×4 for example. Both matrices have same amount of data, namely 1024 elements. The three-dimensional matrix of 16×16×4 can have 1.158×10⁷⁷ key combinations after using key combination of the three-dimensional matrix of the invention; while the two-dimensional matrix of 32×32 can have 1.462×10⁴⁸ key combinations. Obviously, the number of combinations of the three-dimensional matrix is far higher than that of the two-dimensional matrix. Therefore, the capacity of the key database is increased, and availability of the key data package is also enhanced without increasing the data size based on the generation algorithm of multi-dimensional key.

In the present management application, the private key base matrix is only preserved by key generation center for generating private key, and is issued to an applicant user along with the base matrix of public key. The user can obtain the public key of any user off-line by local public key base matrix and generator.

The method of generating multi-dimensional key of the invention has a larger breakthrough in enhancing the availability of the key. Therefore, in the cases of adopting this invention method, key generation center can assign a private key to a user, while issuing public key of users to other users as data package all at once. For example, in the mobile terminal application such as cell phones and etc., a terminal can query the public key of other terminals locally. Additionally, users can file a refresh application for public key data package at a regular time to key generation center. However, the authentication process after refreshment is operated off-line, which embodies the self-authenticated process.

What is claimed is:

1. A method of generating multi-dimensional key, comprising, both generating three-dimensional coordinate sequences and generating public key and private key: wherein the step of generating three-dimensional coordinate sequences is: setting a three-dimensional key base matrix as M, comprising of key elements, each layer in a three-dimensional matrix being a two-dimensional matrix Mₖ sized m×l along Z axis, wherein, m is the number of rows in each layer of l is the number of columns in each layer; the public key and private key are generated in a manner consistent with the generation of the three-dimensional coordinate sequences.

2. The method of generating multi-dimensional key according to claim 1, wherein generating three-dimensional coordinate sequences particularly includes following steps:
1) setting the three-dimensional matrix to include h two-dimensional matrices Mₖ having m rows and l columns along Z axis, wherein, k=1, . . . , h;
2) firstly, conducting Hash transformation to ID to generate High dimensional Coordinate sequence P for element selection from key matrices,
P=Hash(ID)=[P₁ . . . Pₖ . . . Pₕ]
wherein, Pₖ corresponds to the two-dimensional coordinate sequence of two-dimensional matrix of Mₖ of the k^{th} layer, including l units, which corresponds to the number of columns of Mₖ;
Pₖ=[pₖ₁pₖ₂ . . . pₖₗ]
wherein, pⱼₖ, j=1, 2, . . . , l, which is the row coordinate of the elements to be picked up from the j^{th} column of the two-dimensional matrix Mₖ extending in x and y axis direction, the value ranges from 1 to m;
3) P can be expressed in a two-dimensional form. It contains h 1×l vectors Pₖ:
$$\begin{matrix}P = [ \begin{matrix}{P}_{1} \\ {P}_{2} \\ ⋮ \\ {P}_{h}\end{matrix} ] \\ = [ \begin{matrix}{p}_{11} & {p}_{12} & … & {p}_{1 l} \\ {p}_{21} & {p}_{22} & … & {p}_{2 l} \\ ⋮ & ⋮ & ⋱ & ⋮ \\ {p}_{h 1} & {p}_{h 2} & … & {p}_{hl}\end{matrix} ]\end{matrix}$$
Wherein, pₖⱼ, k=1, 2, . . . , h; j=1, 2, . . . , l, which indicates the row ordinates of the elements picked up from the j^{th} column in the two-dimensional matrix Mₖ, k=1, 2, . . . , h of k^{th} layer, with pₖⱼ being 0≦pₖⱼ≦m, k=1, 2, . . . , h; j=1, 2, . . . , l.

3. The method of generating multi-dimensional key according to claim 2, wherein for even higher dimensional key base matrices, the coordinate sequences of the elements to be picked up from the base matrix are determined using the method of generating three-dimensional coordinate sequences.

4. The method of generating multi-dimensional key according to claim 1, wherein generating the public key and private key includes following steps:
1) for high-dimensional matrices of public key and private key, the elements to be picked up are obtained by the method of generating three-dimensional coordinate sequences, taking a three-dimensional matrix for example, the public key matrix and private key matrix are R_{m×l×h} and r_{m×l×h}, respectively,
the elements which public key matrix corresponds to
R̅=[Rₚ_{₁₁} . . . Rₚ_{₁ₗ}Rₚ_{₂₁} . . . Rₚ_{₂ₗ} . . . Rₚ_{ₕₗ}],
the elements which private key matrix corresponds to
r̅=[rₚ_{₁₁} . . . rₚ_{₁ₗ}rₚ_{₂₁} . . . rₚ_{₂ₗ} . . . rₚ_{ₕₗ}];
the subscript pᵢⱼ, i=1, 2, . . . , h, j=1, 2, . . . , l of corresponding elements of above public key matrix and private key matrix correspond to the elements in the three-dimensional coordinate sequence, i indicates that the public key element and private key element Rₚ_{ᵢⱼ}, rₚ_{ᵢⱼ} is in the ith layer of the public key matrix and private key matrix R_{m×l×h} and r_{m×l×h}, j indicates that the public key element and private key element Rₚ_{ᵢⱼ}, rₚ_{ᵢⱼ} is in the j th column of the ith layer of the public key matrix and private key matrix R_{m×l×h} and r_{m×l×h}, pᵢⱼ indicates that the public key element and private key element Rₚ_{ᵢⱼ}, rₚ_{ᵢⱼ} are in the pᵢⱼth row of the jth column in the ith layer matrix of the public key matrix and private key matrix R_{m×l×h} and r_{m×l×h};
2) the identity private key as
$$SK ( ID ) = {\sum }_{i}^{ } {r}_{i} mod n$$
which a user corresponds to is obtained by a key generation center based on the picking up method of matrix elements in above step 1), wherein, n is the order of additive group of an elliptic curve; any user can fetch the public key of a user as
$$PK ( ID ) = {\sum }_{i} {R}_{i}$$
using an open public key matrix;
3) there are m^{l} combination ways in each layer of the three-dimensional matrix, therefore, there are (m^{l})^{h} combination ways in the three-dimensional combination matrix, m, l, h indicate the row number, the column number and the layer number of the three-dimensional public key matrix and private key matrix, respectively.
